(19) United States
(12) Patent Application Publication
(10) Pub. No.: US 2025/0191339 A1
(43) Pub. Date: Jun. 12, 2025

(54) METHOD, APPARATUS, ELECTRONIC DEVICE, AND STORAGE MEDIUM FOR CLASSIFYING MULTIMEDIA CONTENT

(71) Applicant: Beijing Zitiao Network Technology Co., Ltd., Beijing (CN)

(72) Inventors: Wenzhao GAO, Beijing (CN); Hao XU, Beijing (CN); Shaohui JIAO, Beijing (CN)

(21) Appl. No.: 18/972,164

(22) Filed: Dec. 6, 2024

(30) Foreign Application Priority Data
Dec. 6, 2023 (CN) 202311667500.6

(51) Int. Cl. G06V 10/764; G06V 10/774; G06V 10/82; G06V 20/40

(52) U.S. Cl. CPC G06V 10/764; G06V 10/774; G06V 20/41; G06V 10/82

(57) ABSTRACT

The embodiments of the present disclosure provide a method and apparatus for classifying multimedia content, electronic device, and storage medium. The method comprises: acquiring a category and an object category confidence degree of a target object within a multimedia content to be classified; determining a first multimedia content within the multimedia content to be classified based on the object category confidence degree, and determining a prompt based on the category of the target object within the first multimedia content; and identifying a category of the first multimedia content based on the prompt.

### CROSS-REFERENCE TO RELATED APPLICATION(S)

This application claims priority to Chinese Application No. 202311667500.6 filed Dec. 6, 2023, the disclosure of which is incorporated herein by reference in its entity.

### FIELD

Embodiments of the present disclosure relate to data processing technology and, in particular, to a method and apparatus, electronic device, and storage medium for classifying multimedia content.

### BACKGROUND

At present, by classifying multimedia content and generating category labels corresponding to the multimedia content based on the classification results, content recommendation may be achieved based on the category labels.

### SUMMARY

Embodiments of the present disclosure provide a method and apparatus content, electronic device, and storage medium for classifying multimedia.

In a first aspect, an embodiment of the present disclosure provides a method for classifying multimedia content, comprising: acquiring a category and an object category confidence degree of a target object within a multimedia content to be classified; determining a first multimedia content within the multimedia content to be classified based on the object category confidence degree, and determining a prompt based on the category of the target object within the first multimedia content; and identifying a category of the first multimedia content based on the prompt.

In a second aspect, an embodiment of the present disclosure further provides an apparatus for classifying multimedia content, comprising: an acquiring module, configured to acquire a category and an object category confidence degree of a target object within a multimedia content to be classified; a determining module, configured to determine a first multimedia content within the multimedia content to be classified based on the object category confidence degree, and to determine a prompt based on the category of the target object within the first multimedia content; and an identifying module, configured to identify a category of the first multimedia content based on the prompt.

In a third aspect, an embodiment of the present disclosure further provides an electronic device, comprising: one or more processors; and a storage means configured to store one or more programs; wherein the one or more programs, when executed by the one or more processors, cause the one or more processors to implement the method for classifying multimedia content according to any of the embodiments of the present disclosure.

In a fourth aspect, an embodiment of the present disclosure further provides a storage medium containing computer-executable instructions, wherein the computer-executable instructions, when executed by a computer processor, perform the method for classifying multimedia content according to any of the embodiments of the present disclosure.

### BRIEF DESCRIPTION OF THE DRAWINGS

In conjunction with the accompanying drawings and with reference to the following detailed implementations, the above and other features, advantages, and aspects of the embodiments of the present disclosure will become more apparent. Throughout the drawings, the same or similar reference numerals represent the same or similar components. It should be understood that the drawings are illustrative, and the elements and components are not necessarily drawn to scale.

FIG. 1 is a flowchart illustrating a method for classifying multimedia content according to an embodiment of the present disclosure;

FIG. 2 is a flowchart illustrating another method for classifying multimedia content according to an embodiment of the present disclosure;

FIG. 3 is a flowchart illustrating a method for classifying videos according to an embodiment of the present disclosure;

FIG. 4 is a schematic diagram illustrating the structure of an apparatus for classifying multimedia content according to an embodiment of the present disclosure; and

FIG. 5 is a schematic diagram illustrating the structure of an electronic device according to an embodiment of the present disclosure.

### DETAILED DESCRIPTION OF EMBODIMENTS

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as being limited to the embodiments set forth herein. On the contrary, these embodiments are provided to provide a more thorough and complete understanding of the present disclosure. It should be understood that the drawings and embodiments of the present disclosure are only for exemplary purposes and are not intended to limit the protection scope of the present disclosure.

It should be understood that the respective steps described in the method implementations of the present disclosure may be performed in different orders and/or in parallel. In addition, the method implementations may include additional steps and/or omit the execution of the illustrated steps. The scope of the present disclosure is not limited in this respect.

The term “comprising” and its variations are used herein in an open-ended manner, meaning “including but not limited to”. The term “based on” is “at least partially based on”. The term “an embodiment” means “at least one embodiment”; the term “another embodiment” means “at least one additional embodiment”; and the term “some embodiments” means “at least some embodiments”. Related definitions of other terms will be given in the following description.

It should be noted that the concepts of “first”, “second” and the like mentioned in the present disclosure are only used to differentiate different devices, modules or units, and are not intended to limit the order or interdependence of the functions performed by these devices, modules or units.

It should be noted that the modifiers “a”, “an” and “multiple” as mentioned in the present disclosure are illustrative rather than limiting. Those skilled in the art should understand that unless explicitly stated otherwise in the context, they should be understood as “one or more”.

The names of the messages or information exchanged between the multiple means in the embodiments of the present disclosure are for illustrative purposes only and are not intended to limit the scope of these messages or information.

It should be understood that the data involved in this technical solution (including but not limited to the data itself, the acquisition or use of the data) should comply with the requirements of relevant laws, regulations and relevant provisions.

The method for classifying multimedia content is generally to train a classification model based on a large amount of manually annotated data, and then classify the multimedia content through the classification model. The classification accuracy of multimedia content is limited by the amount of training data and the classification capability of the model, leading to a problem of inaccurate classification of some multimedia content that lacks sufficient training data, which subsequently affects content recommendations.

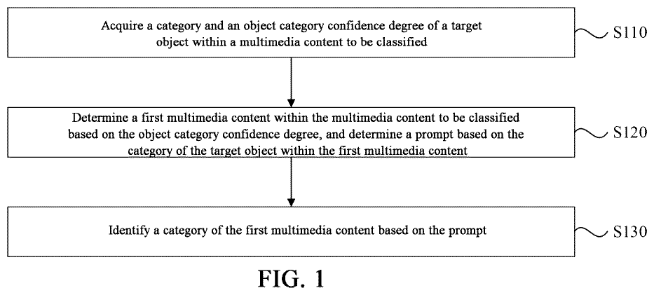

FIG. 1 is a flowchart illustrating a method for classifying multimedia content according to an embodiment of the present disclosure. The embodiments of the present disclosure are applicable to the situation of multimedia content classification, such as identifying the scene of the genre of a video or image. The method may be performed by an apparatus for classifying multimedia content, which may be implemented in the form of software and/or hardware, and alternatively, by an electronic device, which may be a mobile terminal, a PC or a server, etc.

As shown in FIG. 1, the method comprises the following steps.

At S110, a category and an object category confidence degree of a target object within a multimedia content to be classified are acquired.

Therein, the multimedia content to be classified may be multimedia content whose category attributes are to be determined in the resource set. The category attributes may represent the genre, topic or scene to which the multimedia content belongs. For example, the multimedia content to be classified may include multimedia content without category labels. Alternatively, the multimedia content to be classified may also include multimedia content whose category labels are to be updated. Therein, the multimedia content may include videos or images, etc.

Therein, the target object may represent the category mark included in the multimedia content to be classified, and the category mark may represent the category attribute of the multimedia content to be classified. For example, the target object may be an official logo, etc., and the category attribute of the multimedia content to which the object belongs may be determined by the category of the target object. If the multimedia content to be classified includes the official logo of the set activity, the category attribute of the multimedia content to be classified is determined based on the official logo. The object category confidence degree is used to represent the probability of accurately identifying the category corresponding to the target object. For example, if the object category confidence degree of the target object category a is 0.9, the probability of determining that the conclusion that the target object category is a is an accurate identification result is 90%.

Exemplarily, acquiring the category and the object category confidence degree of the target object within the multimedia content to be classified comprises: acquiring the multimedia content to be classified, and inputting the multimedia content to be classified into a first identifying model, wherein a training sample set of the first identifying model comprises a multimedia content sample generated based on identification data corresponding to a target category; and acquiring an identification result corresponding to the multimedia content to be classified output by the first identifying model, and the identification result comprises position, category, and object category confidence degree of the target object within the multimedia content to be classified.

Therein, the first identifying model may be a neural network model. For example, the neural network module may include an encoder and a decoder, and the category of the multimedia content is determined by the encoder and the decoder. The identification data can be used to represent the target category. A video of a set activity is acquired, and identification data indicating the video category may appear in the video. The identification data is acquired for constructing the training sample set. For example, a video of conference A is acquired, and the official logo of conference A may be acquired from the video frames included in the video as identification data, and conference A is determined as the target category corresponding to the identification data.

In some embodiments, generating the multimedia content sample based on identification data corresponding to the target category comprises: acquiring identification data corresponding to the target category; generating simulated identification data based on the identification data, wherein the identification data represents an identification in a first form, and the simulated identification data represents an identification in a second form; and fusing the simulated identification data with a preset multimedia content to obtain the multimedia content sample.

Exemplarily, multimedia content with a category label is acquired, and the category label is used to represent the category of the multimedia content as a target category. Identification data used to identify the target category in the multimedia content is acquired. The identification data is processed by preset data to obtain simulated identification data, and the identification data is used to represent the identification in the first form; the simulated identification data is used to represent the identification in the second form. For example, the identification data is color enhanced and perspective transformed to obtain simulated identification data, and the simulated identification data is closer to the form of the identification in the real world, which enhances the robustness and generalization of the first identifying model. Then, the simulated identification data is fused with the preset multimedia content to obtain a multimedia content sample. Therein, the preset multimedia content may include pre-acquired images or videos, etc.

Because images in the real world are affected by factors such as shooting environment, shooting angle, and shooting equipment, the identification data in the image and the pre-acquired identification data have different degrees of deformation or color difference. In order to acquire an effect closer to the identification data in the real image, the pre-acquired image is used as the background image, and the simulated identification data is fused with the background image through the image fusion algorithm, so that the brightness, saturation and other hue parameters of the foreground and background match, so that the simulated identification data is more realistically fused with the background image, and an image sample of the fused simulated identification data is obtained to simulate the display effect of the identification data in the image in the real world. If the preset multimedia content is a video, the above fusion operation is performed on the video frames included in the video respectively to obtain a video sample of the fused simulated identification data to simulate the display effect of the identification data in the video in the real world.

Alternatively, in the process of fusing the simulated identification data with the preset multimedia content, a part of the preset multimedia content may be selected, to identify the plane area in the preset multimedia content, to fuse the simulated identification data into the plane area. For example, the simulated identification data is fused into platforms such as walls, floors, and desktops. The fusion position of the simulated identification data is not limited for another part of the preset multimedia content.

For multimedia content samples, sample labels are determined based on simulated identification data fused to the background image, sample pairs are generated based on the multimedia content samples and the corresponding sample labels, and training sample sets are constructed based on the sample pairs, which may improve the problems of slow efficiency and high labor costs in manual labeling.

Taking the multimedia content samples being image samples as an example, the process of training the first identifying model based on the training sample set is explained. The image samples are divided into image blocks, each image block is linearly embedded, position embedding and classification tags are added, and an image vector sequence is generated. The image vector sequence is input into the encoder of the first identifying model, the encoder encodes the image identification sequence, and then classifies the image blocks in combination with the classification tags and the classifier to obtain the encoding information matrix and classification information. Then, the encoding information matrix and classification information are input into the decoder, the relationship between the image blocks is calculated through the multi-head attention mechanism, and the predicted category corresponding to the image sample is output. Then, based on the loss value of the predicted category and the sample label, the model parameters of the first identifying model are adjusted through back propagation.

At S120, a first multimedia content within the multimedia content to be classified is determined based on the object category confidence degree, and a prompt is determined based on the category of the target object within the first multimedia content.

Therein, the first multimedia content may represent the multimedia content to be classified that meets the first preset condition. The first preset condition may include that the object category confidence degree of the first multimedia content belongs to a preset confidence degree interval. For example, the first preset condition may be that the comprehensive result of the object category confidence degree of the target object at each position in the image belongs to the preset confidence degree interval. Therein, the image may be a picture or a video frame in a video. The comprehensive result may be the average, median, maximum or minimum value of the object category confidence degree, etc.

The prompt is used to assist the second identifying model in understanding the input first multimedia content. The second identifying model may include a multimodal graphic model. By inputting the first multimedia content and the prompt into the multimodal graphic model, using the global understanding ability of the multimodal graphic model for multimedia content, and prompting the category attribute of the first multimedia content through the prompt, the multimodal graphic model may be assisted to better understand the first multimedia content, thereby outputting the category of the first multimedia content.

Exemplarily, determining the first multimedia content within the multimedia content to be classified based on the object category confidence degree, and determining the prompt based on the category of the target object within the first multimedia content comprises: comparing the object category confidence degree of the multimedia content to be classified with a first preset condition, to obtain the first multimedia content that meets the first preset condition; and acquiring a prompt template, and generating the prompt by combining the category of the target object within the first multimedia content with the prompt template.

Since the multimedia content to be classified may contain multiple target objects, the target confidence degree may be determined according to the object category confidence degree corresponding to the target object at each position. For each the multimedia content to be classified, the target confidence degree corresponding to the multimedia content to be classified is compared with the first preset condition. If the target confidence degree belongs to the confidence degree area included in the first preset condition, it is determined that the multimedia content to be classified corresponding to the target confidence degree meets the first preset condition, and the multimedia content to be classified is used as the first multimedia content. It should be noted that the first multimedia content is a multimedia content whose category is difficult to determine based on the first identifying model, and needs to be identified twice with the help of the second identifying model.

The prompt template may be a file of a preset organizational format for prompts. The embodiments of the present disclosure do not limit the specific format of the prompt template. For example, the prompt template may include: detection/identification of identification data related to xxx, or, is the multimedia content of xxx genre?

A prompt template and a category of a target object in the first multimedia content are acquired, and the category of the target object in the first multimedia content is added to the prompt template according to the area to be filled in the prompt template to generate a prompt.

For example, if it is identified that the categories of the target objects at respective positions in the multimedia content to be classified are the same, the average of the confidence degrees of the object categories at respective positions is calculated as the average confidence degree. If the average confidence degree belongs to the preset confidence degree interval corresponding to the first preset condition, the multimedia content to be classified is taken as the first multimedia content. If the average confidence degree is less than the lower limit value of the preset confidence degree interval corresponding to the first preset condition, it is determined that the category of the multimedia content to be classified is not an identified category. If the average confidence degree is greater than the upper limit value of the preset confidence degree interval corresponding to the first preset condition, it is determined that the category of the multimedia content to be classified is an identified category.

If it is identified that the categories of the target objects at respective positions in the multimedia content to be classified are different, the average confidence degrees of the object category confidence degrees of the positions with the same category are calculated respectively, and then it is determined whether the maximum average confidence degree belongs to the preset confidence degree interval corresponding to the first preset condition. If so, the multimedia content to be classified is taken as the first multimedia content. If the maximum average confidence degree is less than the lower limit value of the preset confidence degree interval corresponding to the first preset condition, it is determined that the category of the multimedia content to be classified is not an identified category. If the maximum average confidence degree is greater than the upper limit of the preset confidence degree interval corresponding to the first preset condition, the category of the multimedia content to be classified is determined to be the category corresponding to the object category confidence degree corresponding to the maximum average confidence degree.

At S130, a category of the first multimedia content is identified based on the prompt.

Exemplarily, inputting the prompt and the first multimedia content into a second identifying model, wherein a training sample set of the second identifying model comprises an image-text sample pair, and text information in the image-text sample pair is determined based on an image description of a corresponding image; acquiring an identification result corresponding to the first multimedia content output by the second identifying model; and combining the first multimedia content with the identification results of corresponding to the first identifying model and the second identifying model respectively, to determine the category of the first multimedia content.

In the embodiment of the present disclosure. the second identifying model may include a multimodal image-text model, etc. Since the multimodal image-text model is trained based on massive data resources, it has the ability to globally understand multimedia content. In order to enable the multimodal image-text model to have a more comprehensive global understanding of the image content, the multimodal image-text model may be fine-tuned using image-text sample pairs, comprising: acquiring the image in the target scene, inputting the image into the large language model, and acquiring the image description output by the large language model; combining the image description and the prompt template to generate the prompt corresponding to each image; and, forming the image and the corresponding prompt as an image-text sample pair, and constructing a training sample set of the second identifying model based on the image-text sample pair.

The second identifying model may be a multimodal image-text model that performs image editing based on the input prompt. The multimodal image-text model is fine-tuned using the training sample set of the second identifying model to obtain a second identifying model. The second identifying model may complete the image understanding task guided by the prompt.

Taking the first multimedia content being the target image as an example, if the prompt is “Is the target image of xxx genre?” the prompt and the target image are input into the second identifying model, and the second identifying model outputs the category and content category confidence degree of the target image, wherein the content category confidence degree represents the confidence degree that the image is of xxx genre.

The second identifying model may provide more accurate global image content understanding and classification for images in complex scenes that are difficult for the first identifying model to accurately identify. Although the classification accuracy of the second identifying model is higher than that of the first identifying model, the running speed of the second identifying model is slower. Using the second identifying model combined with the first identifying model for multimedia content classification may balance the accuracy and running speed of the classification method.

The technical solutions of the embodiment of the present disclosure classify the multimedia content to be classified in advance, obtain a category and an object category confidence degree of a target object within a multimedia content to be classified, then screen out a first multimedia content based on the object category confidence degree, determine a prompt based on the category of the target object within the first multimedia content, and then re-identify a category of the first multimedia content based on the prompt. By re-identifying part of the multimedia content to be classified, the accuracy of multimedia content classification may be improved, and the problem that the current multimedia content classification methods cannot accurately classify part of the multimedia content is solved, thereby contributing to improving the precision of content recommendations.

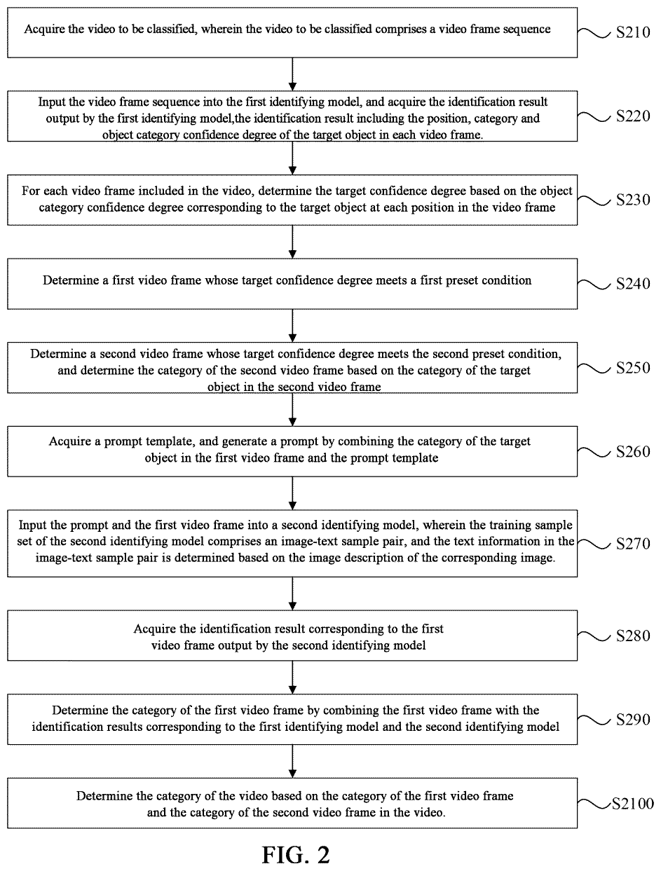

FIG. 2 is a flowchart illustrating another method for classifying multimedia content according to an embodiment of the present disclosure. Based on the above embodiments, the embodiments of the present disclosure take the multimedia content to be classified being a video as an example to elaborate on the video classification method. As shown in FIG. 2, the method comprises the following steps.

At S210, the video to be classified is acquired, wherein the video to be classified comprises a video frame sequence.

At S220, the video frame sequence is input into the first identifying model, and the identification result output by the first identifying model is acquired, and the identification result includes the position, category and object category confidence degree of the target object in each video frame.

At S230, for each video frame included in the video, the target confidence degree is determined based on the object category confidence degree corresponding to the target object at each position in the video frame.

Exemplarily, for each video frame included in the video, the category and object category confidence degree corresponding to the target object at each position in the video frame are acquired, and the average confidence degree of the video frame is calculated based on the object category confidence degree corresponding to each position as the target confidence degree.

It should be noted that the embodiments of the present disclosure do not limit the specific determination method of the target confidence degree. In addition to determining the target confidence degree by the method provided in the embodiments of the present disclosure, the target confidence degree may also be determined based on the median, maximum value, or minimum value of the object category confidence degree corresponding to each position, or the like.

At S240, a first video frame whose target confidence degree meets a first preset condition is determined.

Exemplarily, for each video frame included in the video, the target confidence degree corresponding to the video frame is compared with the first preset condition to obtain a first video frame that meets the first preset condition. For example, the first preset condition may include a preset confidence degree interval. If the target confidence degree corresponding to the video frame belongs to the preset confidence degree interval corresponding to the first preset condition, it is determined that the video frame meets the first preset condition and is used as the first video frame.

At S250, a second video frame whose target confidence degree meets the second preset condition is determined, and the category of the second video frame is determined based on the category of the target object in the second video frame.

Exemplarily, for each video frame included in the video, the target confidence degree corresponding to the video frame is compared with the second preset condition to obtain a second video frame that meets the second preset condition. For example, the second preset condition may include a preset confidence degree interval. If the target confidence degree corresponding to the video frame belongs to the preset confidence degree interval corresponding to the second preset condition, it is determined that the video frame meets the second preset condition and is used as the second video frame. The lower limit of the preset confidence degree interval corresponding to the second preset condition is the same as the upper limit of the preset confidence degree interval corresponding to the first preset condition, and the value belongs to only one of the two preset confidence degree intervals. For example, the preset confidence degree interval corresponding to the second preset condition may be [x %, 1], and the preset confidence degree interval corresponding to the first preset condition may be [n %, x %), and n %<x %<1.

Since the target confidence degree corresponding to the second video frame meets the second preset condition, the category of the target object in the second video frame is determined as the category of the second video frame.

At S260, a prompt template is acquired, and a prompt is generated by combining the category of the target object in the first video frame and the prompt template.

Exemplarily, for the first video frame in the video, a prompt template is acquired, and a prompt is generated by combining the category of the target object in the first video frame and the prompt template.

At S270, the prompt and the first video frame are input into a second identifying model, wherein the training sample set of the second identifying model comprises an image-text sample pair, and the text information in the image-text sample pair is determined based on the image description of the corresponding image.

At S280, the identification result corresponding to the first video frame output by the second identifying model is acquired.

Therein, the identification result of the second identifying model for the first video frame comprises the category, position, object category confidence degree, content category confidence degree, etc. of the target object in the first video frame.

Exemplarily, for each first video frame in the video, the prompt corresponding to the first video frame and the first video frame are input into the second identifying model, and the position, category, object category confidence degree, and content category confidence degree of the first video frame output by the second identifying model are acquired.

At S290, the category of the first video frame is determined by combining the identification results of the first video frame corresponding to the first identifying model and the second identifying model.

Alternatively, combining the identification results of the first identifying model corresponding to the output of the first video frame and the identification results of the second identifying model corresponding to the output of the first video frame, the final category of the first video frame is weighted and voted, and the category of the first video frame is decided.

At S2100, the category of the video is determined based on the category of the first video frame and the category of the second video frame in the video.

Therein, the first video frame is a video frame whose target confidence degree meets the first preset condition, and the category of the first video frame is determined by the second identifying model based on the prompt.

Exemplarily, based on the category of the first video frame and the category of the second video frame included in the video, the number of video frames under respective categories is counted. If the number of video frames of a certain category is greater than the set threshold, the classification of the video is determined as the category.

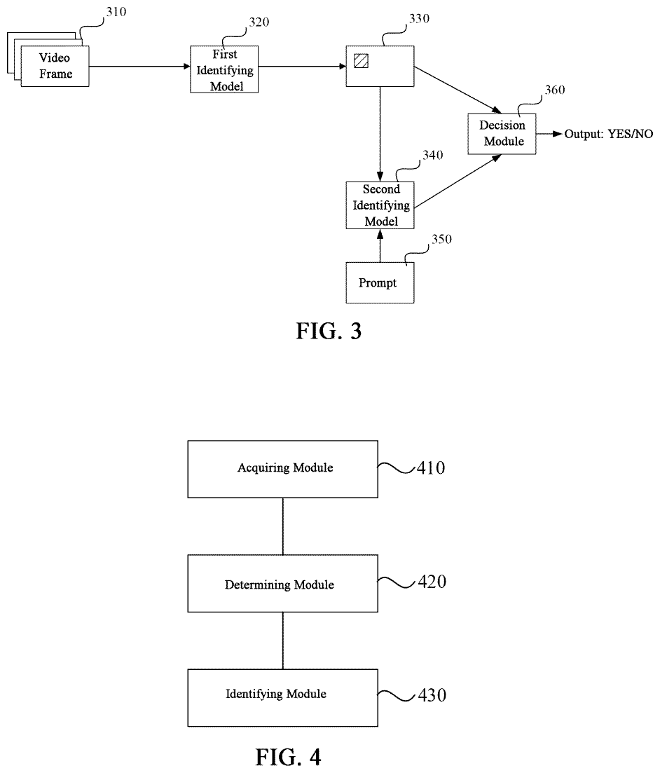

FIG. 3 is a flowchart illustrating a method for classifying videos according to an embodiment of the present disclosure. As shown in FIG. 3, a video frame sequence 310 is input into a first identifying model 320, and the first identifying model 320 outputs an identification results corresponding to respective video frames. Therein, the identification result of the first identifying model 320 comprises the position, category, and object category confidence degree of the target object (e.g., the rectangle filled with oblique lines in the drawing) in the video frame. The first video frame 330 is determined based on the object category confidence degree of each position. The first video frame 330 represents a difficult example that is difficult to accurately identify by the first identifying model. The prompt 350 is generated by combining the category output by the first identifying model corresponding to the first video frame and the prompt template. For example, the prompt may be detection of xxx related identifier. The prompt 350 and the first video frame 330 are input into a second identifying model 340, and the second identifying model 340 outputs an identification result corresponding to the first video frame 330. Therein, the identification result of the second identifying model 340 comprises the position, category, object category confidence degree, and content category confidence degree, etc. of the target object in the first video frame. The identification result corresponding to the first video frame 330 output by the first identifying model 320 and the identification result corresponding to the first video frame 330 output by the second identifying model 340 are respectively input to the decision module 360. The decision module 360 performs a weighted vote on whether the frame is a corresponding category frame based on the position, category and category confidence degree of the target object in the first video frame 330, and the decision model 360 outputs whether the first video frame 330 is a corresponding category frame.

The technical solutions of the embodiment of the present disclosure use the first identifying model to identify and classify the target object in the video frame. For the first video frame whose classification is untrustworthy, the second identifying model is used to perform a secondary understanding and target object identification on the first video frame, and the category of the first video frame is determined by combining the two identification results. Then, the video category is determined based on the category of the first video frame and the category of the second video frame in the video, and the second identifying model is used to perform a secondary identification and classification on the first video frame whose classification is untrustworthy in the video, so as to take into account both the classification speed and the classification accuracy.

FIG. 4 is a schematic diagram illustrating the structure of an apparatus for classifying multimedia content according to an embodiment of the present disclosure. The apparatus may be implemented in the form of software and/or hardware, and alternatively, may be implemented by an electronic device, which may be a mobile terminal, a PC or a server, etc.

As shown in FIG. 4, the apparatus comprises: an acquiring module 410, a determining module 420 and an identifying module 430.

The acquiring module 410 is configured to acquire a category and an object category confidence degree of a target object within a multimedia content to be classified.

The determining module 420 is configured to determine a first multimedia content within the multimedia content to be classified based on the object category confidence degree, and to determine a prompt based on the category of the target object within the first multimedia content.

The identifying module 430 is configured to identify a category of the first multimedia content based on the prompt.

Alternatively, the acquiring module 410 is specifically configured to: acquire the multimedia content to be classified; and input the multimedia content to be classified into a first identifying model, and acquire an identification result corresponding to the multimedia content to be classified output by the first identifying model, the identification result comprising position, category, and object category confidence degree of the target object within the multimedia content to be classified, wherein a training sample set of the first identifying model comprises a multimedia content sample generated based on identification data corresponding to a target category.

Further, generating the multimedia content sample based on identification data corresponding to the target category comprises: acquiring identification data corresponding to the target category; generating simulated identification data based on the identification data, wherein the identification data represents an identification in a first form, and the simulated identification data represents an identification in a second form; and fusing the simulated identification data with a preset multimedia content to obtain the multimedia content sample.

Alternatively, the determining module 420 is specifically configured to: compare the object category confidence degree of the multimedia content to be classified with a first preset condition, to obtain the first multimedia content that meets the first preset condition; and acquire a prompt template, and generating the prompt by combining the category of the target object within the first multimedia content with the prompt template.

Alternatively, the identifying module 430 is specifically configured to: input the prompt and the first multimedia content into a second identifying model, wherein a training sample set of the second identifying model comprises an image-text sample pair, and text information in the image-text sample pair is determined based on an image description of a corresponding image; acquire an identification result corresponding to the first multimedia content output by the second identifying model; and combine the first multimedia content with the identification results corresponding to the first identifying model and the second identifying model respectively, to determine the category of the first multimedia content.

Alternatively, the multimedia content to be classified comprises a video; the apparatus further comprises: a target confidence degree determining module, configured to determine the target confidence degree for each video frame included in the video based on the object category confidence degree corresponding to the target object at each position in the video frame after acquiring the identification result corresponding to the multimedia content to be classified output by the first identifying model; and a category determining module, configured to determine the second video frame whose target confidence degree meets the second preset condition, and determine the category of the second video frame based on the category of the target object in the second video frame.

Alternatively, the apparatus further comprises: a video classifying module, configured to determine the category of the video based on the category of the first video frame and the category of the second video frame in the video, wherein the first video frame is a video frame whose target confidence degree meets the first preset condition, and the category of the first video frame is determined by the second identifying model based on the prompt.

The apparatus for classifying multimedia content provided in the embodiment of the present disclosure can execute the method for classifying multimedia content provided in any of the embodiments of the present disclosure, and has the corresponding functional modules and beneficial effects of the executing the method.

It should be noted that the various units and modules included in the above-mentioned apparatus are only divided according to functional logic, but are not limited to the above-mentioned division, as long as the corresponding functions can be achieved; in addition, the specific names of the respective functional units are only for the convenience of distinguishing each other, and are not intended to limit the protection scope of the embodiments of the present disclosure.

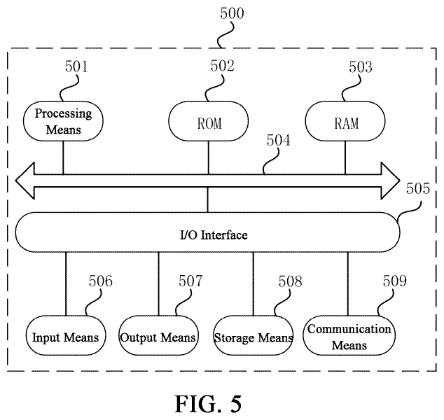

FIG. 5 is a schematic diagram illustrating the structure of an electronic device according to an embodiment of the present disclosure. Referring to FIG. 5 below, it shows a schematic structural diagram of an electronic device (such as a terminal device or server in FIG. 5) 500 suitable for implementing the embodiments of the present disclosure. The terminal devices in the embodiments of the present disclosure may include but are not limited to mobile terminals such as mobile phones, laptops, digital broadcast receivers, PDAs (personal digital assistants), PADs (tablet computers), PMPs (portable multimedia players), vehicle-mounted terminals (such as vehicle-mounted navigation terminals), etc., and fixed terminals such as digital TVs, desktop computers, etc. The electronic device shown in FIG. 5 is only an example and should not impose any restrictions on the functions and scope of use of the embodiments of the present disclosure.

As shown in FIG. 5, the electronic device 500 may include a processing means (such as a central processing unit, a graphics processor, etc.) 501, which can perform a variety of appropriate actions and processes according to a program stored in a read-only memory (ROM) 502 or a program loaded from a storage device 508 to a random access memory (RAM) 503. In RAM 503, a variety of programs and data required for the operation of the electronic device 500 are also stored. The processing means 501, ROM 502, and RAM 503 are connected to each other via a bus 504. An input/output (I/O) interface 505 is also connected to the bus 504.

Typically, the following means may be connected to the I/O interface 505: input means 506 such as, for example, a touch screen, touchpad, keyboard, mouse, camera, microphone, accelerometer, gyroscope, etc.; output means 507 such as, for example, a liquid crystal display (LCD), speaker, vibrator, etc.; storage means 508 such as, for example, a magnetic tape, hard disk, etc.; and communication means 509. The communication means 509 may allow the electronic device 500 to engage in wireless or wired communication with other devices to exchange data. Although FIG. 5 illustrates electronic device 500 having various means, it should be understood that it is not required to implement or include all the means shown. Alternatively, more or fewer means may be implemented or included.

In particular, according to an embodiment of the present disclosure, the process described above with reference to the flowchart may be implemented as a computer software program. For example, an embodiment of the present disclosure comprises a computer program product including a computer program carried on a non-transitory computer-readable medium, the computer program including a program code for executing the method shown in the flowchart. In such an embodiment, the computer program may be downloaded and installed from the network through the communication means 509, or installed from the storage means 508, or installed from the ROM 502. When the computer program is executed by the processing means 501, the above functions defined in the method of the embodiment of the present disclosure are executed.

The names of the messages or information exchanged between the multiple means in the embodiments of the present disclosure are for illustrative purposes only and are not intended to limit the scope of these messages or information.

The electronic device provided by the embodiment of the present disclosure belongs to the same invention concept as the display method provided by the above embodiment. The technical details not described in detail in this embodiment can be referred to the above embodiment, and this embodiment has the same beneficial effects as the above embodiment.

An embodiment of the present disclosure provides a computer storage medium, on which a computer program is stored, and the program implements the display method provided by the above embodiment when executed by the processor.

It should be noted that the computer-readable medium described above in the present disclosure may be a computer-readable signal medium, a computer-readable storage medium, or any combination of the two above. The computer-readable storage medium may be, but is not limited to, an electrical, magnetic, optical, electromagnetic, infrared, or semiconductor system, means, or device, or any combination thereof. More specific examples of computer-readable storage media may include, but are not limited to: electrical connections having one or more wires, portable computer disks, hard disks, random access memory (RAM), read-only memory (ROM), erasable programmable read-only memory (EPROM or flash memory), fiber optics, portable compact disk read-only memory (CD-ROM), optical storage means, magnetic storage means, or any suitable combination of the above. In the present disclosure, a computer-readable storage medium may be any tangible medium that contains or stores a program that can be used by or in combination with an instruction execution system, means, or device. In the present disclosure, a computer-readable signal medium may include a data signal propagated in a baseband or as part of a carrier wave, in which a computer-readable program code is carried. Such propagated data signals may take a variety of forms, including but not limited to electromagnetic signals, optical signals, or any suitable combination of the above. A computer-readable signal medium that may also be any computer-readable medium other than a computer-readable storage medium can transmit, propagate, or convey a program for use by or in combination with an instruction execution system, means, or device. The program code contained on a computer-readable medium may be transmitted by any suitable means, including but not limited to electrical wiring, optical cables, RF (radio frequency), and any suitable combination of the above.

In some implementations, the client and the server may communicate using any currently known or future developed network protocol such as HTTP (HyperText Transfer Protocol), and may be interconnected with any form or medium of digital data communication (e.g., communication network). Examples of communication networks include local area networks (“LAN”), wide area networks (“WAN”), internets (e.g., the Internet), and peer-to-peer networks (e.g., ad hoc peer-to-peer networks), as well as any currently known or future developed networks.

The above-mentioned computer-readable medium may be contained in the above-mentioned electronic device; or it may exist separately without being assembled into the electronic device.

The computer-readable medium carries one or more programs. When the one or more programs are executed by the electronic device, the electronic device: acquires a category and an object category confidence degree of a target object within a multimedia content to be classified; determines a first multimedia content within the multimedia content to be classified based on the object category confidence degree, and determines a prompt based on the category of the target object within the first multimedia content; and identifies a category of the first multimedia content based on the prompt.

The computer program code for performing the operations of the present disclosure may be written in one or more programming languages or a combination thereof, including but not limited to object-oriented programming languages such as Java, Smalltalk, C++, as well as conventional procedural programming languages such as the “C” language or similar programming languages. The program code may execute entirely on the user's computer, partially on the user's computer, as a standalone software package, partially on the user's computer and partially on a remote computer, or entirely on a remote computer or server. In the case of remote computers, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the possible implementation architecture, functions, and operations of the systems, methods, and computer program products according to various embodiments of the present disclosure. In this regard, each box in the flowchart or block diagram may represent a module, a program segment, or a portion of a code, which contains one or more executable instructions for implementing the specified logical functions. It should also be noted that in some alternative implementations, the functions indicated in the box may also occur in an order different from that indicated in the accompanying drawings. For example, two boxes represented in succession may actually be executed substantially in parallel, and they may sometimes be executed in reverse order, depending on the functions involved. It should also be noted that each box in the block diagram and/or flowchart, and the combination of boxes in the block diagram and/or flowchart, may be implemented by a dedicated hardware-based system that performs the specified function or operation, or may be implemented by a combination of dedicated hardware and computer instructions.

The units involved in the embodiments described in the present disclosure may be implemented by software or by hardware. Therein, the name of the unit does not constitute a limitation on the unit itself in some cases.

The functions described above herein may be at least partially performed by one or more hardware logic components. For example, without limitation, exemplary types of hardware logic components that may be used include: field programmable gate arrays (FPGA), application-specific integrated circuits (ASIC), application-specific standard products (ASSP), system on a chip (SOC), complex programmable logic devices (CPLD), etc.

In the context of the present disclosure, a machine-readable medium may be a tangible medium that can contain or store a program for use by or in connection with an instruction execution system, means, or device. The machine-readable medium may be a machine-readable signal medium or a machine-readable storage medium. The machine-readable medium may include, but is not limited to, electronic, magnetic, optical, electromagnetic, infrared, or semiconductor systems, means, or devices, or any suitable combination of the above. More specific examples of machine-readable storage media may include electrical connections based on one or more wires, portable computer disks, hard disks, random access memory (RAM), read-only memory (ROM), erasable programmable read-only memory (EPROM or flash memory), optical fiber, portable compact disk read-only memory (CD-ROM), optical storage devices, magnetic storage devices, or any suitable combination of the above.

The above description is only the preferred embodiments of the present disclosure and the explanation of the technical principles used. Those skilled in the art should understand that the scope of the disclosure covered in the present disclosure is not limited to the technical solutions formed by particular combinations of the above-described technical features, but should also cover other technical solutions formed by any combination of the above-described technical features or equivalent features thereof without departing from the above-described disclosure concepts, such as technical solutions formed by interchanging the above-described features with technical features with similar functions disclosed in the present disclosure (but not limited to).

In addition, although the operations are depicted in a specific order, this should not be understood as requiring these operations to be performed in the specific order shown or in a sequential order. In certain environments, multitasking and parallel processing may be advantageous. Similarly, although several specific implementation details are included in the above discussion, these should not be interpreted as limiting the scope of the present disclosure. Certain features described in the context of separate embodiments can also be implemented in a single embodiment in combination. Conversely, the various features described in the context of a single embodiment can also be implemented in multiple embodiments individually or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are merely example forms of implementing the claims.

I/We claim:

1. A method for classifying multimedia content, comprising:
acquiring a category and an object category confidence degree of a target object within a multimedia content to be classified;
determining a first multimedia content within the multimedia content to be classified based on the object category confidence degree, and determining a prompt based on the category of the target object within the first multimedia content; and
identifying a category of the first multimedia content based on the prompt.

2. The method according to claim 1, wherein acquiring the category and the object category confidence degree of the target object within the multimedia content to be classified comprises:
acquiring the multimedia content to be classified, and inputting the multimedia content to be classified into a first identifying model, wherein a training sample set of the first identifying model comprises a multimedia content sample generated based on identification data corresponding to a target category; and
acquiring an identification result corresponding to the multimedia content to be classified output by the first identifying model, wherein the identification result comprises position, category, and object category confidence degree of the target object within the multimedia content to be classified.

3. The method according to claim 2, wherein generating the multimedia content sample based on identification data corresponding to the target category comprises:
acquiring identification data corresponding to the target category;
generating simulated identification data based on the identification data, wherein the identification data represents an identification in a first form, and the simulated identification data represents an identification in a second form; and
fusing the simulated identification data with a preset multimedia content to obtain the multimedia content sample.

4. The method according to claim 1, wherein determining the first multimedia content within the multimedia content to be classified based on the object category confidence degree, and determining the prompt based on the category of the target object within the first multimedia content comprises:
comparing the object category confidence degree of the multimedia content to be classified with a first preset condition, to obtain the first multimedia content that meets the first preset condition; and
acquiring a prompt template, and generating the prompt by combining the category of the target object within the first multimedia content with the prompt template.

5. The method according to claim 2, wherein identifying the category of the first multimedia content based on the prompt comprises:
inputting the prompt and the first multimedia content into a second identifying model, wherein a training sample set of the second identifying model comprises an image-text sample pair, and text information in the image-text sample pair is determined based on an image description of a corresponding image;
acquiring an identification result corresponding to the first multimedia content output by the second identifying model; and
combining the first multimedia content with the identification results corresponding to the first identifying model and the second identifying model respectively, to determine the category of the first multimedia content.

6. The method according to claim 2, wherein the multimedia content to be classified comprises a video; and after acquiring the identification result corresponding to the multimedia content to be classified output by the first identifying model, the method further comprises:
for each video frame included in the video, determining a target confidence degree based on the object category confidence degree corresponding to the target object at each position in the video frame; and
determining a second video frame whose target confidence degree meets a second preset condition, and determining a category of the second video frame based on the category of the target object in the second video frame.

7. The method according to claim 6, further comprising:
determining the category of the video based on the category of the first video frame and the category of the second video frame, wherein the first video frame is a video frame whose target confidence degree meets the first preset condition, and the category of the first video frame is determined by the second identifying model based on the prompt.

8. An electronic device, comprising:
one or more processors; and
a storage means configured to store one or more programs;
wherein the one or more programs, when executed by the one or more processors, cause the one or more processors to:
acquire a category and an object category confidence degree of a target object within a multimedia content to be classified;
determine a first multimedia content within the multimedia content to be classified based on the object category confidence degree, and determining a prompt based on the category of the target object within the first multimedia content; and
identify a category of the first multimedia content based on the prompt.

9. The device according to claim 8, wherein the programs causing the device to acquire the category and the object category confidence degree of the target object within the multimedia content to be classified comprise the programs causing the device to:
acquire the multimedia content to be classified, and inputting the multimedia content to be classified into a first identifying model, wherein a training sample set of the first identifying model comprises a multimedia content sample generated based on identification data corresponding to a target category; and
acquire an identification result corresponding to the multimedia content to be classified output by the first identifying model, wherein the identification result comprises position, category, and object category confidence degree of the target object within the multimedia content to be classified.

10. The device according to claim 9, wherein the programs causing the device to generate the multimedia content sample based on identification data corresponding to the target category comprise the programs causing the device to:
acquire identification data corresponding to the target category;
generate simulated identification data based on the identification data, wherein the identification data represents an identification in a first form, and the simulated identification data represents an identification in a second form; and
fuse the simulated identification data with a preset multimedia content to obtain the multimedia content sample.

11. The device according to claim 8, wherein the programs causing the device to determine the first multimedia content within the multimedia content to be classified based on the object category confidence degree, and determine the prompt based on the category of the target object within the first multimedia content comprise the programs causing the device to:
compare the object category confidence degree of the multimedia content to be classified with a first preset condition, to obtain the first multimedia content that meets the first preset condition; and
acquire a prompt template, and generate the prompt by combining the category of the target object within the first multimedia content with the prompt template.

12. The device according to claim 9, wherein the programs causing the device to identify the category of the first multimedia content based on the prompt comprises the programs causing the device to:
input the prompt and the first multimedia content into a second identifying model, wherein a training sample set of the second identifying model comprises an image-text sample pair, and text information in the image-text sample pair is determined based on an image description of a corresponding image;
acquire an identification result corresponding to the first multimedia content output by the second identifying model; and
combine the first multimedia content with the identification results corresponding to the first identifying model and the second identifying model respectively, to determine the category of the first multimedia content.

13. The device according to claim 9, wherein the multimedia content to be classified comprises a video; and after acquiring the identification result corresponding to the multimedia content to be classified output by the first identifying model, the device is further caused to:
for each video frame included in the video, determine a target confidence degree based on the object category confidence degree corresponding to the target object at each position in the video frame; and
determine a second video frame whose target confidence degree meets a second preset condition, and determining a category of the second video frame based on the category of the target object in the second video frame.

14. The device according to claim 13, wherein the device is further caused to:
determine the category of the video based on the category of the first video frame and the category of the second video frame, wherein the first video frame is a video frame whose target confidence degree meets the first preset condition, and the category of the first video frame is determined by the second identifying model based on the prompt.

15. A non-transitory storage medium containing computer-executable instructions, wherein the computer-executable instructions, when executed by a computer processor, causing the processor to:
acquire a category and an object category confidence degree of a target object within a multimedia content to be classified;
determine a first multimedia content within the multimedia content to be classified based on the object category confidence degree, and determining a prompt based on the category of the target object within the first multimedia content; and
identify a category of the first multimedia content based on the prompt.

16. The medium according to claim 15, wherein the instructions causing the processor to acquire the category and the object category confidence degree of the target object within the multimedia content to be classified comprise the instructions causing the processor to:
acquire the multimedia content to be classified, and inputting the multimedia content to be classified into a first identifying model, wherein a training sample set of the first identifying model comprises a multimedia content sample generated based on identification data corresponding to a target category; and
acquire an identification result corresponding to the multimedia content to be classified output by the first identifying model, wherein the identification result comprises position, category, and object category confidence degree of the target object within the multimedia content to be classified.

17. The medium according to claim 16, wherein the instructions causing the processor to generate the multimedia content sample based on identification data corresponding to the target category comprise the instructions causing the processor to:
acquire identification data corresponding to the target category;
generate simulated identification data based on the identification data, wherein the identification data represents an identification in a first form, and the simulated identification data represents an identification in a second form; and
fuse the simulated identification data with a preset multimedia content to obtain the multimedia content sample.

18. The medium according to claim 15, wherein the instructions causing the processor to determine the first multimedia content within the multimedia content to be classified based on the object category confidence degree, and determine the prompt based on the category of the target object within the first multimedia content comprise the instructions causing the processor to:
compare the object category confidence degree of the multimedia content to be classified with a first preset condition, to obtain the first multimedia content that meets the first preset condition; and
acquire a prompt template, and generate the prompt by combining the category of the target object within the first multimedia content with the prompt template.

19. The medium according to claim 16, wherein the instructions causing the processor to identify the category of the first multimedia content based on the prompt comprises the instructions causing the processor to:
input the prompt and the first multimedia content into a second identifying model, wherein a training sample set of the second identifying model comprises an image-text sample pair, and text information in the image-text sample pair is determined based on an image description of a corresponding image;
acquire an identification result corresponding to the first multimedia content output by the second identifying model; and
combine the first multimedia content with the identification results corresponding to the first identifying model and the second identifying model respectively, to determine the category of the first multimedia content.

20. The medium according to claim 16, wherein the multimedia content to be classified comprises a video; and after acquiring the identification result corresponding to the multimedia content to be classified output by the first identifying model, the processor is further caused to:
for each video frame included in the video, determine a target confidence degree based on the object category confidence degree corresponding to the target object at each position in the video frame; and
determine a second video frame whose target confidence degree meets a second preset condition, and determining a category of the second video frame based on the category of the target object in the second video frame.
